(19) United States
(12) Patent Application Publication
(10) Pub. No.: US 2014/0172609 A1
(43) Pub. Date: Jun. 19, 2014

(54) SYSTEM AND METHOD FOR TRADING DIGITAL ASSETS BETWEEN MOBILE DEVICES

(71) Applicant: Francois Dupoteau, Toronto (CA)

(72) Inventor: Francois Dupoteau, Toronto (CA)

(21) Appl. No.: 13/714,468

(22) Filed: Dec. 14, 2012

(51) Int. Cl. G06Q 20/12

(52) U.S. Cl. CPC G06Q 20/1235
USPC 705/26.1

(57) ABSTRACT

A mobile device and method are disclosed for trading a digital asset with a buyer device. The method provides for publishing a publicly available list of digital assets from the selling mobile device that can be accessed by potential buyer mobile devices over a network. The seller mobile device evaluates a certificate associated with the digital asset to determine what trading rights are available to the seller device and what payment obligations to interested parties are associated with the digital asset. The payment obligations allow for revenue sharing between the seller device and the interested party as specified in the certificate. The seller mobile device verifies that the payment obligations are satisfied based on the terms of the trade for the digital asset and then transmits the digital asset to the buyer device.

### FIELD

The present disclosure relates generally to mobile computing devices. More particularly, the disclosure relates to distribution of digital assets between mobile computing devices.

### BACKGROUND

Mobile devices are often used by individuals to store and consume digital assets, particularly digital media such as audio, video and electronic books. Mobile devices have a processor, memory, connected display and a network interface, and can include mobile phones, laptops, media players, video game consoles, and tablet computers. The digital assets consumed on mobile devices are typically downloaded from a central store available over the internet. Examples of central digital asset stores include e-commerce websites/services such as Amazon and iTunes.

The central server approach to distributing digital assets can be inefficient. Distributing electronic files to multiple devices over the Internet from a central server requires a tremendous amount of bandwidth. Central stores often use content delivery networks to attempt to distribute this load among multiple data servers at increased costs. A central server approach also require centrally implementing digital rights management and payment infrastructure.

Mobile devices are increasingly becoming the preferred devices for consuming digital assets and browsing the Internet. Due to the limited display size of mobile devices it is difficult to effectively market to a central store to attract customers. A central server approach is also limited because it requires the user to connect to a particular website or use a particular software application.

### SUMMARY

According to a first aspect, a method for trading a digital asset between a seller mobile device and a buyer mobile device is provided. The method comprises publishing a public digital asset list from the seller device, the list containing an identifier of the digital asset on the first seller mobile device, the public digital asset list accessible over a network; receiving a trade request at the seller device for the digital asset from the buyer device; determining payment obligations to an interested party associated with the digital asset; verifying payment obligations are satisfied; notifying the interested party of the digital asset trade between the seller device and the buyer device; and transmitting the digital asset to the buyer device over the network. In some aspects, the network can be a personal area network, and can comprise any one of Bluetooth, ad hoc wireless, shared local area network, and infrared.

In other aspects, the method can further comprising evaluating a certificate associated with the digital asset to determine if a trading right is associated with the digital asset, and inserting the identifier of the digital asset on the list based on the trading right. In some aspects the trading right can be obtained from a third party and the certificate can be updated to allow trading.

In some other aspects, the method can verify payment by determining if an account associated with the seller device has sufficient credit to meet payment obligations of to the interested party. The payment obligations can be specified in a certificate associated with the digital asset. The payment obligations can also specify a portion of payment associated with the seller device to allow revenue sharing with the seller device.

In still other aspects, notifying the interested party can include providing payment information to the interested party, such as a rights owner and a digital asset server.

According to another aspect, a mobile device is provided for trading a digital asset. The mobile device comprises a memory for storing instructions; a processor coupled to the memory for executing the instructions to configure the processor to: publish a public digital asset list, the public digital asset list containing an identifier of the digital asset on the mobile device, the public digital asset list accessible through a network interface of the mobile device; receive a trade request for the digital asset; determine payment obligations associated with the digital asset; verify payment obligations are satisfied; notify an interested party of the digital asset trade between the seller device and the buyer device; and transmitting the digital asset over the network interface of the mobile device. The network interface can operates based on any one of Bluetooth, ad hoc wireless, shared local area network, and infrared to provide a personal area network.

In other aspects, the processor can be further configured to evaluate a certificate associated with the digital asset to determine if a trading right is associated with the digital asset, and insert the identifier of the digital asset on the public digital asset list based on the trading right. In some aspects, the processor can be further configured to obtain a trading right from an interested party through the network interface and update the certificate to allow trading.

In some other aspect, the processor can be further configured to verify payment to determine if an account associated with the seller device has sufficient credit to meet payment obligations to the interested party. The payment obligations can be specified in a certificate associated with the digital asset. The payment obligations can also specify a portion of payment associated with the seller device.

In still other aspects, notifying the interested party can include providing payment information to the interested party, such as a rights owner and a digital asset server.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of a digital asset trading system that allows the transfer of digital assets between mobile devices;

FIG. 2 is a block diagram illustrating the components of the first and second mobile device of FIG. 1;

FIG. 3 is a flow chart illustrating a process for trading digital assets between a seller mobile device and a buyer mobile device; and

FIG. 4 is a block diagram illustrating an exemplary device architecture of a mobile device implementing the features and operations described in reference to FIGS. 1-3.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

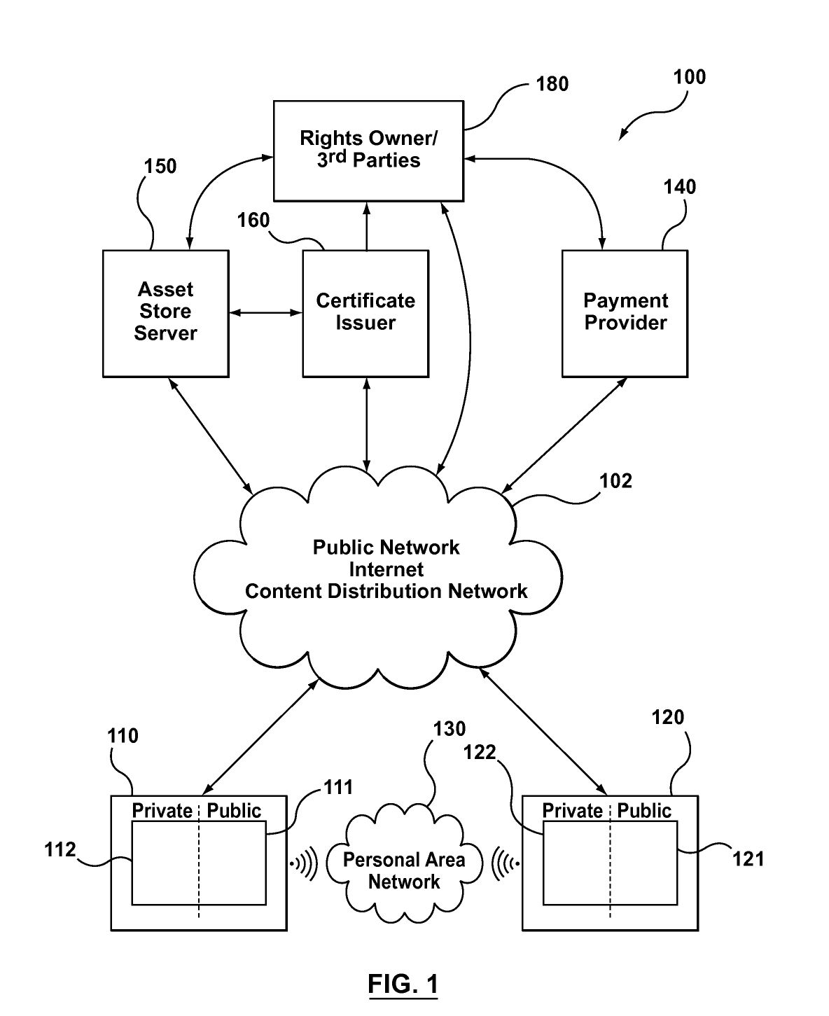

Reference is first made to FIG. 1, shown is a block diagram of a digital asset trading system 100 that allows a first mobile device 110 to transfer a digital asset to a second mobile device 120 over a personal area network 130. Second mobile device 120 can view digital assets for sale on first mobile device 110 over personal area network 130 and initiate a transaction to purchase a digital asset. Payment for the digital asset transaction can be provided by a payment provider 140 that processes a payment from the purchaser to credit an account of a seller and other third parties associated with the digital asset purchased.

Asset Server:

First mobile device 110 can acquire a digital asset from a digital asset server 150 that provides a repository of digital assets that are offered for sale over a public network 102, such as the internet, to user's of mobile devices 110, 120. User's of mobile devices 110, 120 can direct a web browser or use a specific client application on their mobile device in order to view digital assets that are available for purchase from digital asset server. Examples of uses of digital asset servers include the iTunes Store and App Store, available from Apple Computer, Inc., of Cupertino, Amazon online music and e-book stores available from Amazon.com, of Seattle, or the Google Play store, available from Google Inc., of Mountainview. Digital asset server 150 can also include a website of a developer that offers digital assets for sale over public network 102.

Payment Provider:

User's can purchase digital assets for download onto their mobile devices 110, 120 on a per digital asset fee or subscription model. Payment can be coordinated by payment provider 140. After payment has been verified, digital assets can be delivered over a content distribution network to the user's mobile devices 110, 120. Payment provider 140 can distribute payments for the digital asset amongst the owners/operators of the asset server 150, certificate issuer 160 and rights owners and other third parties 180. Payment provider 140 can also distribute payments between users of mobile devices 110, 120 in compensation for re-selling or redistributing a digital asset between mobile devices 110, 120, either owned by the user or asset store 150.

Payment provider 140 can be an online payment processor, similar to functions provided by PayPal Inc. of San Jose, that allows payments and money transfers to be made through a public network 102. Payment provider 140 can also comprise traditional banking or credit institutions, such as credit card company or bank, for example, that provide credit or banking payment transactions for an account with payment provider 140. Payment provider 140 can function in conjunction with a digital wallet on mobile devices 110, 120, and can further incorporate a near-field communication interface of mobile devices 110, 120 to provide payments. In other embodiments, payment provider 140 can be associated with digital asset server 150 to include payment accounts managed by digital asset server 150.

Digital Assets:

In addition to digital asset server 150, mobile devices can obtain digital assets from other sources. Some examples include digital assets created by the mobile device user, such as an original song, book or software application, that the user installs on their mobile device. Digital assets can also be acquired from other sources connected to public network 102, such as, for example, a web server, a usenet server, or a peer-to-peer sharing network. Digital assets can also be obtained from other mobile devices, as will be explained further below.

Digital assets can be any type of file that represents data, including digital media, such as audio, video, graphics or other multimedia content that can be used by a mobile device. Digital assets can also be applications that the users of mobile devices 110, 120 can execute to provide additional functionality to the mobile device. Digital assets can also be files used by common desktop applications, including office suites or engineering packages, such as spreadsheet files, word processor files; e-mail message files, calendar files, CAD drawings, and other document files. Digital assets can also be used to represent ownership of real-world assets such that a real-world asset can be transferred by altering rights of the digital asset. For example, a digital asset could be used to contain ownership information of a vehicle as certified by a registration authority and transferring and altering the digital asset could be used to reflect a change in ownership of the vehicle in a sale transaction.

A digital asset can be unprotected or protected by a digital rights management (DRM) protocol that limits access to the digital asset. An unprotected digital asset is not subject to use limitations that may be imposed by a DRM protocol. A DRM protocol can be implemented to protect digital assets provided by digital asset server 150 or to protect assets developed and distributed by a mobile device 110. The DRM protocol can involves the creation of a rights file associated with each digital asset contained on a user's mobile device 110, 120. This rights file details the rights the user has purchased in relation to the requested data. The rights file may be transmitted to the mobile device either together or separately with the digital asset. Mobile device 110 implements the DRM protocol by examining the downloaded rights file and ensures that the purchaser is only permitted to use the digital asset in accordance with the specified rights.

Certificate Issuer:

Certificate issuer 160 can provide a digital rights management (DRM) service to digital asset server 150, rights owners 180, and mobile devices 110, 120 through the provision of certificates. A certificate can specify the rights associated with the digital asset and whether a user can share or resell the associated digital asset. Certificate issuer 160 can execute content protection routines to protect and restrict the use of the digital asset through generation of certificates that are used with a DRM protocol. Certificates associated with digital assets can be generated based on what rights are allowed for the associated digital asset, the user's account with asset server, or a combination of features. For example, a certificate can reflect a rights owner restricting previews of the digital asset to thirty seconds and only allow re-seller rights to a user with a particular class of user account or located in a particular country.

Certificate issuer 160 or digital asset server 150 can encapsulate the digital asset in a digital rights management container that has an encrypted copy of the digital asset. The encapsulated digital asset can also include the certificate setting out any rights or limitation of rights, or the certificate can be a separate file that can be encrypted or encapsulated separately. The certificate can also contain the decryption key to access the associated digital asset. The encapsulated digital asset can also be encrypted to prevent tampering with the certificate or unauthorized copying of the digital asset.

Digital asset server 150 can request a certificate directly from certificate issuer 160 prior to encapsulating the digital asset. If first mobile device 110 wants to alter a certificate to obtain resale rights, for example, then first mobile device 110 can contact digital asset server 150 where the digital asset was originally obtained or the original rights owner 180 to request an updated certificate. Alternatively, first mobile device 110 can directly contact certificate issuer 160 to obtain an updated certificate. In some embodiments, some of the functionality of certificate issuer 160 can be embodied in first mobile device 110 to allow the mobile device to directly update or create certificates once permission is obtained from digital asset server 150 or rights owner 180.

The certificate can be a separate file, such as an XML or similar type of file, that is linked to the digital asset. Alternatively, the certificate can be encapsulated in the DRM container or as a file header of the digital asset.

The certificate can contain a number of rights that are associated with the digital asset. In addition to the right to trade or resell a digital asset, the certificate can also indicate: how many times a user or mobile device can trade the digital asset; identification of rights owner 180; a minimum price that can be charged, an amount due on a trade to any of the digital asset server 150, rights owner 180 and certificate issuer 160; and an fee or revenue percentage due to user of first mobile device. Each of these rights can be separately controlled and can have separate keys to limit which rights can be altered by certificate issuer 160 and mobile devices 110,120. This can be used to prevent first mobile device 110 from being able to alter certain rights of the certificate.

The certificate can ensure that any resale transactions only happens on terms that are acceptable to digital asset server 150, certificate issuer 160 or rights owners 180. In some embodiments, mobile devices 110, 120 can directly request rights from rights owner 180. The rights owner 180 can grant the right to mobile devices 110, 120 that can then perform the certificate issuing function to alter the certificate according the rights granted by rights owner 180. The right granted by the rights owner and reflected by the certificate can unique to a user, mobile device, list of sellers or be seller agnostic.

Mobile Devices:

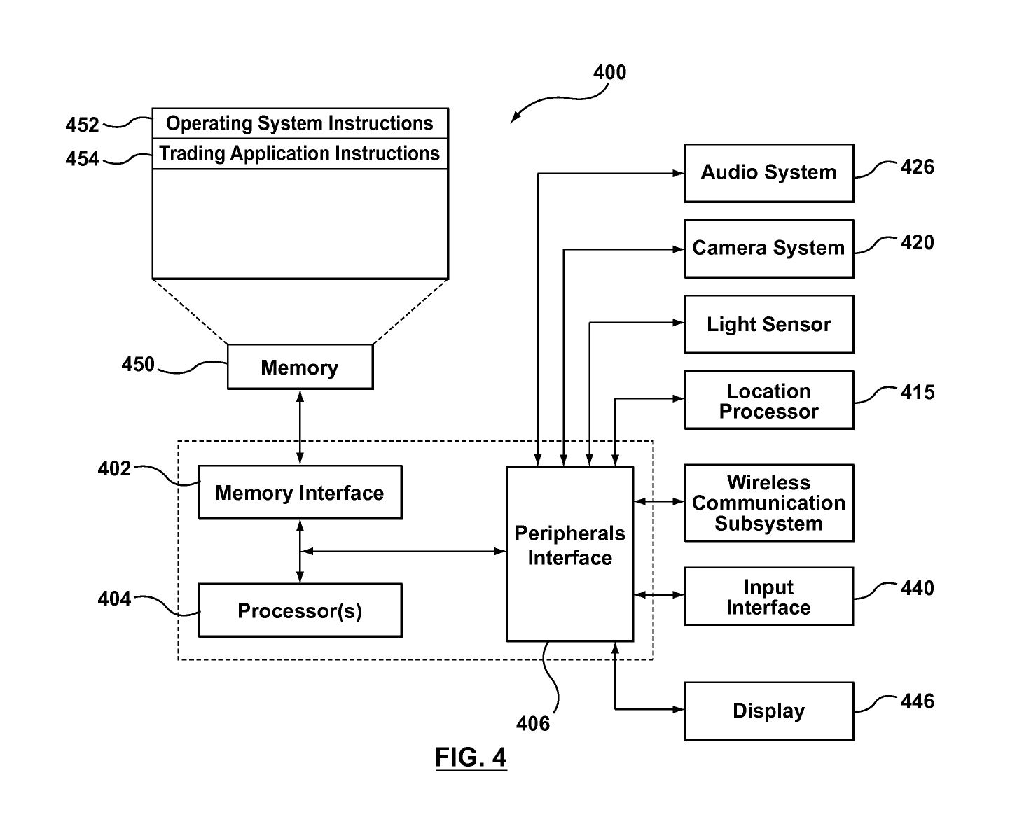

Mobile devices 110, 120 include one or more network interfaces to interface with any one of public network 102 and personal area network 130. Personal area network 130 can include ad-hoc wireless networks between mobile devices, a shared local area network, Bluetooth or infrared. In some embodiments, personal area network 130 can be formed over public network 102 to connect mobile devices 110, 120. Mobile devices 110, 120 are computing devices that include a processor and memory that allow mobile devices 110, 120 to be configured for multiple functions. An example architecture is provided in FIG. 4, and is described further below. Implementations of mobile device can include, but are not limited to, a cellular telephone, a portable media viewer (e.g. music/video player, e-book reader), a laptop, personal digital assistant, a video game console, or other general computing devices.

Mobile devices 110, 120 include a logical separation between public digital assets 111, 121 and private digital assets 112, 122. Private digital assets 112, 122 can only be used by their respective mobile device 110, 120 while public digital assets 111, 121 can be shared with other mobile devices. Certificates provided by certificate issuer 160 can be used to indicate the public or private status of a digital asset and whether that asset can be shared by a user or the mobile device. 110, 120. The separation between private and public digital assets can be provided by an operating system layer of mobile devices 110, 120, or alternatively, the separation can be provided in the application layer by an application that controls access to digital assets associated with user's or mobile devices.

Traditional Digital Asset Acquisition:

In a typical digital asset distribution system a user of mobile device 110 must access digital asset server 150 to select a particular digital asset for download. If the digital asset is a not offered for free, user of mobile device 110 must accept payment terms that debit a user's account with payment provider 140 and credit an account owned by digital asset server 150. If the digital asset is not protected by DRM it can then be downloaded by mobile device 110 over internet 102. If DRM is to provided to limit usage of the digital asset then certificate issuer 160 can provide a certificate at the request of digital asset server 150 and the digital asset can be encapsulated in a DRM container that limits access to the digital asset by mobile device 110. In this traditional digital asset distribution model, digital assets are centrally stored and distributed by asset server 150.

Inter-Device Trading:

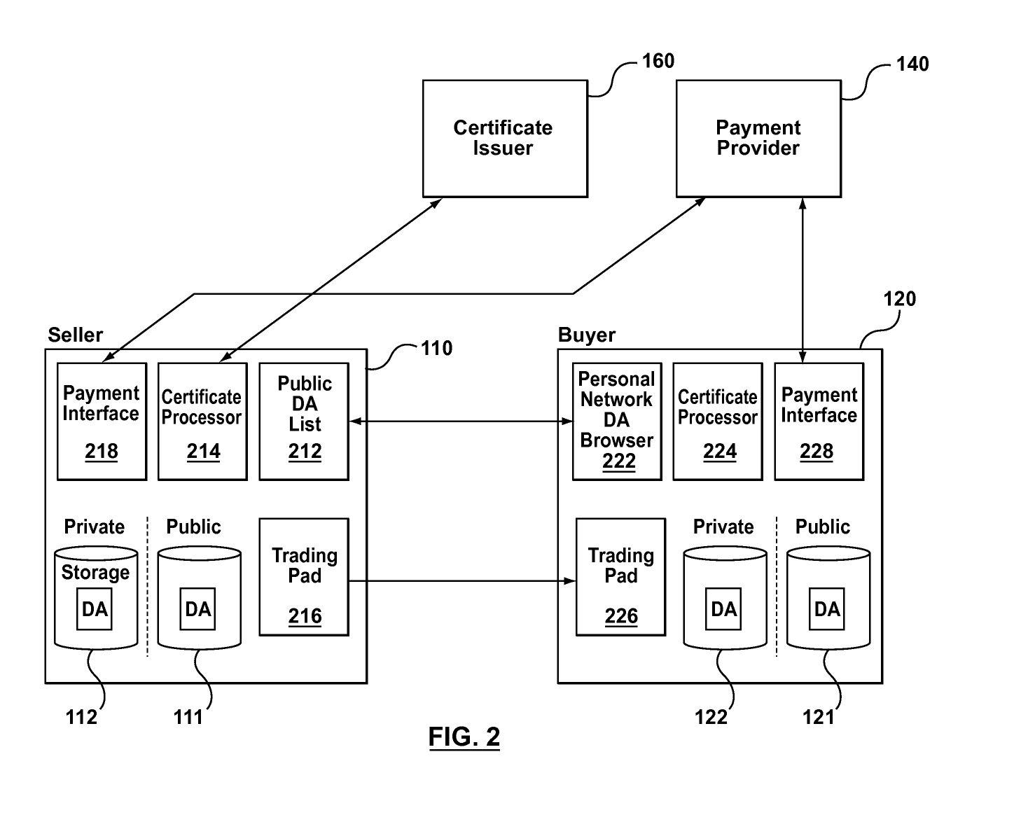

Referring now to FIG. 2, a block diagram illustrating the components of first mobile device 110 and second mobile device 120 to provide digital asset trading from first mobile device 110 to second mobile device 120. In the example provided in FIG. 2, first mobile device 110 will be referred to as a seller device 110 and second mobile device 120 will be referred to as buyer device 120. Buyer device 110 and seller device 120 can communicate over a personal area network 130, and in other embodiments, they can communicate over a public network such as the internet. Typically, both mobile devices 110, 120 would share similar components but for simplicity of illustration seller device 110 is shown with seller functional components and buyer device is shown with buyer functional components.

User of buyer device 120 operates digital asset browser 222 to search for and select digital assets for purchase. Digital asset browser 222 can connects over a network to any nearby mobile devices that are offering digital assets for trade. Seller device 110 provides a public digital asset list 212 that lists digital assets that seller device 110 is offering for trade. In some embodiments, seller device 110 can search for potential buyer devices 120 and push public digital asset list 212 to digital asset browser 222 of buyer device 120. Digital asset browser 222 can be scanning/listening on network waiting for possible seller mobile device 110 to connect to the network and announce their presence to digital browser 212. When digital asset browser 222 connects to a seller device 110, digital asset browser 222 will download public digital asset list 212 to present to user of buyer device 120.

Public Digital Asset List:

Public digital asset list 212 can contain information associated with digital assets, such as name of digital asset (e.g. song, book, or movie name), description, price, graphic previews (e.g. graphic icons or preview images of the digital asset), a link to further information on available over the internet. Other information about digital assets in public digital asset list 212 can include data provided by seller or the seller's usage statistics related to the digital assets. Examples can include text of seller's review, a scale rating (e.g. 4/5 stars), a popularity score based on seller's play count, and a tag indicating if seller is currently enjoying a particular digital asset. Public digital asset list 212 can also include an identifier to seller device and can also include information about the user, such as a user profile that can include, for example, a picture/avatar, preferences for genres of digital assets.

A seller can also add additional information to the digital asset and use tools available inside the trading application, for example, to communicate with potential buyers. Tools provided can include a chat room, preview application, documentation repository, video, demo file and viewer.

In alternative embodiments, seller device 110 can send public digital asset list 212 to a server hosted on the internet 102 to allow access to digital assets from any mobile device 120 that can access the hosted server. Digital asset browser 222 can be configured to access potential digital assets either locally over public area network 130 or over internet 102.

A seller can also specify whitelists or blacklists associated with a digital asset listed on public digital asset list 212. This could allow a seller to offer a digital asset for sale only among those who have rights to buy the digital asset and block potentially unauthorized buyers. The whitelist feature can also be used to specify a friends list or may be pre-populated with users from the seller's contacts, including social network contacts or defined groups of contacts (e.g. friends, family, or co-workers). For example, the trading application on mobile device 110 can request access to a user's contacts or social networks in order to import contacts into a whitelist. The contact information can be used to subscribe to a contact's public digital asset list 212 or send a link if a contact is not currently a user of the trading application. This can allow buyer device 120 to subscribe to a particular seller device 110 so that updates to seller's public digital asset list 212 are communicated to buyer device 120 upon listing through the internet 102 or upon the mobile devices 110, 120 connecting over a personal area network 130. These updates can create notifications or alerts in a subscribing mobile device's trading application. Using whitelists and subscription features can be used to implement a social networking feature between mobile device 110, 120 as a way to advertise and promote digital assets that are shared via public digital asset list 212. The trading application can accumulate all subscribed public digital asset lists 212 to indicate digital assets that may be popular or trending among a contacts.

In some embodiments, if buyer device 120 does not have the trading application then buyer device 120 can connect with seller device 110 to download the trading application. The trading application can be always available via trading pad 216 of seller device 110.

In one embodiment, digital asset browser 222 can be a software application, either separate or part of the trading application, on second mobile device 120 that uses Bluetooth, for example, to locate and connect to seller device 110 when in range. Upon making a network connection and downloading of public digital asset list 212 from seller device 110, user of buyer device 120 would then be notified by digital asset browser 222 that digital assets are available from user of seller device 110. Seller could access the trading application and be presented with user profiles of nearby seller devices 110. User could then select a particular user profile and navigate that user's digital assets that are available for sale.

Seller device 110 further includes a certificate processor 214 that verifies rights associated with digital assets that are stored in associated certificates. Certificate processor 214 can enforce DRM protocols associated with digital assets to restrict usage of the digital assets. A certificate associated with a digital asset can determine whether a user of seller device 110 has a right to trade a digital asset with buyer device 120.

If a user wishes to trade a digital asset then certificate processor 214 must evaluate the certificate associated with the digital asset to determine whether the user has appropriate rights to trade the digital asset. If a user does not have trading rights for a digital asset then that digital asset is stored as a private digital asset 112 and certificate processor 214 limits access to the digital asset to prevent sharing in contravention with the associated certificate. Private digital assets 112 are not eligible for the public digital asset list 212.

A prospective seller device 110 can obtain trading rights for a digital asset by contacting certificate issuer 160 to request trading rights. If a digital asset allows trading rights according to digital asset server 150 and/or rights owners/3^{rd} parties 180, then certificate issuer 160 can provide an updated certificate to seller device 110 that includes the sharing right. The updated certificate can also include terms that specify a price and payment distribution for the digital asset.

In alternative embodiments, certificate processor 214 itself can generate an updated certificate that allows trading rights if it is determined that the digital asset supports the trading right (e.g. an unprotected digital asset or a digital asset with a trading right). In this embodiment, the function of certificate issuer 160 to alter certificates is performed by certificate processor 214 within seller mobile device 110.

After a trading right is obtained, certificate processor 214 can allow storage of the digital asset as a public digital asset 111. Public digital assets 111 can be advertised on public digital asset list 212 and can be accessed by seller trading pad 216 to distribute the digital asset. Placing a digital asset on public digital asset list 212 can be automatic for all assets with a trading right or can be manually placed on public digital asset list 212 by selection of the user of seller mobile device 110. Seller device 110 can also choose the type of transactions for the digital asset, such as trading at a fixed price, a bidding process, or trading for free. The certificate can specify revenue that is due on a trade to any of the rights owner 180, digital asset server 150 or certificate issuer 160. This can allow seller device 110 to give the digital asset away for free or to negotiate for a cash or barter transaction (or other type of transaction that is not supported by payment provider 140) as long as seller device has sufficient credit to pay the revenue due on a trade as specified in the certificate.

Certificate processor 214 can also enforce rights on certificates that limit the trading right. For example, geographic restrictions can be placed on a digital asset that only allow its resale while the mobile device is located in United States of America. Certificate processor 214 can be monitoring geographic location to determine whether to include a digital asset on public digital asset list 212.

Encapsulation:

The process of encapsulating the digital asset and the certificate can be performed by certificate processor 214 on seller device 110 or by certificate issuer 160. The encapsulation process can also encrypt the digital asset to limit access according to the DRM protocol. The encapsulation process can be performed after payment interface 218 has received a confirmation of payment in order to allow the encapsulation process to limit access to the digital asset to a particular device ID or user account that is associated with the buyer or buyer device 120.

Preferably, encapsulation is performed by certificate processor 214 of seller device 110. When seller device obtains authorization to trade a digital asset the encapsulation is performed by seller device 110. If rights owners 180 requests to know the identity of the buyer (e.g. a user identifier or device identifier associated with buyer device 120) then encapsulation can be performed external to seller mobile device 110, such as by certificate issuer 160.

The encryption process can use a variety of key schemes in order to protect the digital asset. In a public key scheme, seller device 110 can encrypt the digital asset using a public key for seller device 120. The public key can be communicated to seller device 110 as part of the request to purchase a digital asset from buyer device 120 or can also be obtained from a server hosted on the internet 102, such as certificate issuer 160, for example. In other embodiments, the encryption key can be a random key that is used to encrypt the certificate and the certificate contains a master key that is used to decrypt the digital asset similar to the FairPlay DRM scheme developed by Apple.

Payment Process:

Buyer device 120 sends a purchase request to seller device 110 to initiate the purchase process. Buyer device 120 can obtain purchase and payment terms associated with a requested digital asset from public digital asset list 212. The purchase request from buyer device 120 can identify the requested digital asset and provide a payment mechanism. The purchase request can also identify a device ID associated with buyer device 120 or a user account used by buyer device 120 that can be used to limit access to the digital asset by a particular device ID or user account. Certificate processor 214 can use the particular device ID or user account to limit usage of the digital asset to buyer device 120 or a user account associated with buyer device 120.

Seller device 110 can use an automatic approval process that waits for payment verification received from payment provider 140 through payment interface 218. Seller device 110 can respond to a buyer device purchase request with an invoice identifier that provides a pointer to an invoice at payment provider 140. Buyer device 130 uses the invoice identifier to provide payment at payment provider 140 from an account associated with buyer device 120. Payment provider 140 can provide payment verification to seller device 110 when payment of the invoice has been satisfied by buyer.

A manual approval process can also be used if a seller uses another payment process that is not supported by payment interface 218. For example, seller can receive cash, barter, payment in an account unsupported by payment provider 140 or a wire transfer, and once the payment amount is satisfied, the seller can provide an indication to seller device 110 that the purchase request has been approved and the delivery process can begin.

In some embodiments, all payment transactions can be performed through payment provider 140 and encapsulation of the digital asset (or providing an updated certificate) can be performed by certificate issuer 160. Buyer device 120 will provide payment through his account with payment provider 140 and payment provider 140 will then distribute the payment according to the prescribed revenue distribution. Payment provider 140 can then distribute portions of the payment to an account of the seller and any third parties (e.g. a rights owner 180 or operator of digital asset server 150). Certificate issuer 160 can also be provided payment in exchange for performing encapsulation or updating certificate associated with the digital asset.

In other embodiments encapsulation of the digital asset can be performed by certificate processor 214 and buyer device 120 will provide payment through his account with payment provider 140. Payment provider 140 can then distribute portions of the payment from buyer to an account of the seller and any accounts of third parties (e.g. a rights owner 180 or operator of digital asset server 150). Upon receiving payment verification at payment interface 218, certificate processor 214 can perform encapsulation or updating of certificate associated with the digital asset.

In other embodiments, payment interface 218 can include a digital wallet that allows seller device 110 to receive payment directly from buyer device 120 and distribute the received payment to third parties. Payment interface 228 of buyer device 120 can initiate payment directly with payment interface 218 over a personal area network 130 or internet 102. After payment interface 218 of seller device 110 has verified payment, then certificate processor 214 can provide an updated certificate or encapsulate the digital asset for transfer to buyer device 120. Payment interface 218 of seller device 110 can redistribute portions of the buyer's payment to third party's, such as rights owner 180 or operator of digital asset server 150 where digital asset was originally acquired. Seller device 110 can redistribute payments according to certificate associated with the digital asset by providing payments to third parties using payment provider 140.

The certificate that is associated with the digital asset can specify how the payment from a buyer is shared. The revenue distribution typically specifies a rights owner of the digital asset, the seller device 110 and can also specify one or more third parties (e.g. operator of originating digital asset server 150, certificate issuer 160). The certificate can specify an amount due to each party upon trading an asset and can specify the amount as a minimum amount or a percentage of the buyer payment. The revenue share to seller device 110 can include additional parameters such as quantity sold or sales level. For example, a seller that has sold over 50 digital assets may qualify for an increased revenue share or a seller may be identified as a preferred seller that is granted increased revenue share.

Asset Delivery Process:

Once payment has been verified delivery of the digital asset from seller device 110 to buyer device 120 can begin. The digital asset can be moved to a trading pad 216 of seller device 110 that allows buyer device 120 to connect using trading pad 226 of buyer device 120. Buyer device 120 can receive a notification to download the digital asset from trading pad 216 that can be used to manually or automatically initiate the downloading of the digital asset.

Alternative embodiments can allow delivery of the digital asset over the internet. For example, a buyer can request that the digital asset be pushed to a server hosted on the internet 102 for later download by buyer device. Also, if the digital asset represents a real, physical asset, then either the buyer or the seller can request to make the asset available in a physical place, such as a warehouse.

Selling Process:

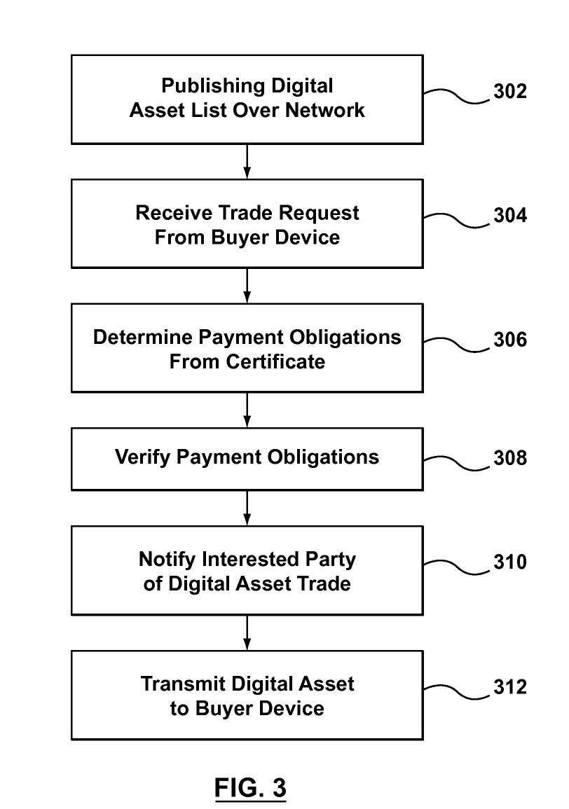

Referring now to FIG. 3, a flowchart is shown illustrating the process for trading digital assets between a seller mobile device 110 and a buyer mobile device 120. At step 302, seller mobile device 110 publishes a public digital asset list 212 containing an identifier to the digital assets for trade so that the public digital asset list 212 can be available over either public network 102 or a person area network 130 to a buyer device 120. A certificate processor 214 of seller device 110 can evaluate a certificate associated with the digital asset to determine if a trading right is associated with the digital asset and placing the identifier to the digital asset on public digital asset list 212 can be based on whether seller device has obtained the trading right as reflected by the certificate. In some cases, seller device 110 may have to contact a rights owner 180 or digital asset server 150 (e.g. where digital asset was originally acquired by seller device 110) to obtain the trading right for the digital asset.

Next, at step 304, seller device 110 will receive a trade request from a buyer device 120 that identifies one of the digital assets published on public digital asset list 212. The request can identify the digital asset and provide a suggest payment method. In some embodiments, the buyer request can also include payment to the seller device 110, such as if seller device can directly accept payment through a digital wallet hosted on seller device 110.

In step 306, seller device 110 can determine what payment requirements are associated with the digital asset requested by the buyer device 120. Payment obligations can be specified in a certificate that is associated with the digital asset and can set out the amount due to an interested party (e.g. third parties/rights owners 180 and/or operator of originating digital asset server 150).

Next, at step 308, seller device 110 must verify that payment obligations are satisfied before transmitting the digital asset to the buyer device in step 312. Verifying payment is dependent on the method of payment used in the transaction. If payment provider 140 is used, then buyer device 120 can send payment to seller device 110 and any other interested parties through payment provider 140 and seller device 110 can obtain verification from payment interface 218 from payment provider. Alternatively, payment can be funded from an account of the seller device 110 (which can be required if the digital asset is given away for free or negotiated without payment provider 140) and seller device 110 must verify that seller's account can provide any payment due to interested parties.

At step 310, seller device 110 provides a notification to the interested party or parties specified in the certificate of a trade between the seller and buyer devices 110, 120. The notification can be payment information that is used to provide payment or a notification that payment has been made using other means (e.g. payment provider 140 or digital wallet on mobile devices 110, 120). Payment information can be a deposit instruction to deposit into an account held by the interested party in order to provide payment to the interested party. For example, if the interested party is digital asset server 150 from which the digital asset originated, then the payment information can include an instruction to transfer credit from the sellers account with digital asset server 150 to the operator of digital asset server 150.

FIG. 4 is a block diagram of an exemplary architecture 400 for the mobile devices of FIGS. 1-2. A mobile device can include memory interface 402, one or more data processors, image processors and/or central processing units 404, and peripherals interface 406. Memory interface 402, one or more processors 404 and/or peripherals interface 406 can be separate components or can be integrated in one or more integrated circuits. The various components in mobile devices 110, 120, for example, can be coupled by one or more communication buses or signal lines.

Sensors, devices, and subsystems can be coupled to peripherals interface 406 to facilitate multiple functionalities. Location processor 415 (e.g., GPS receiver) can be connected to peripherals interface 406 to provide geopositioning.

Camera subsystem 420 can include an optical sensor, e.g., a charged coupled device (CCD) or a complementary metal-oxide semiconductor (CMOS) optical sensor, that can be utilized to facilitate camera functions, such as recording photographs and video clips.

Communication functions can be facilitated through one or more wireless communication subsystems 424, which can include radio frequency receivers and transmitters and/or optical (e.g., infrared) receivers and transmitters. The specific design and implementation of the communication subsystem 424 can depend on the communication network(s) over which a mobile device is intended to operate. For example, a mobile device can include communication subsystems 424 designed to operate over a GSM network, a GPRS network, an EDGE network, a Wi-Fi or WiMax network, and a Bluetooth™ network. In particular, the wireless communication subsystems 424 can include hosting protocols such that the mobile device can be configured as a base station for other mobile devices (e.g. to access public digital asset list 212 and trading pads 216, 226).

Audio subsystem 426 can include a coupled to speaker and microphone to facilitate voice-enabled functions, such as voice recognition, voice replication, digital recording, and telephony functions.

Input interface 440 can include a touch screen controller and/or other input controller(s). Touch-screen controller can be coupled to a display 446. Display and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with surface of display 446.

Other input devices can also be coupled to input interface 440, such as one or more buttons, rocker switches, thumb-wheel, infrared port, USB port, and/or a pointer device such as a stylus. The one or more buttons (not shown) can include an up/down button for volume control of speaker and/or microphone.

Mobile device 400 can present recorded audio and/or video files, such as MP3, AAC, and MPEG files. In some implementations, mobile device 400 can include the functionality of an MP3 player or other media player.

Memory interface 402 can be coupled to memory 450. Memory 450 can include high-speed random access memory and/or non-volatile memory, such as one or more magnetic disk storage devices, one or more optical storage devices, and/or flash memory (e.g., NAND, NOR). Memory 450 can store operating system 452, such as Darwin, RTXC, LINUX, UNIX, OS X, WINDOWS, or an embedded operating system such as VxWorks. Operating system 452 may include instructions for handling basic system services and for performing hardware dependent tasks. In some implementations, operating system 452 can include a kernel (e.g., UNIX kernel).

Memory 450 may also store trading application instructions 754 to implement the functionality described above. Trading application instructions 754 can include software instructions executed by processor 704 that configure mobile device 400 to provide the functions of the trading application. Trading application instructions 754 can include, but are not limited to, instructions related to public and private digital assets, certificate processor 214, 224, payment interface 218, 228, trading pad 216, 226, public digital asset list 212, and digital asset browser 222. In some embodiments, functionality of certificate processor 214 for maintaining the DRM scheme can be part of the operating system that protects the file system of the mobile device 400.

The above identified instructions and applications can correspond to a set of instructions for performing one or more functions described above. These instructions need not be implemented as separate software programs, procedures, or modules. Memory 450 can include additional instructions or fewer instructions. Furthermore, various functions of the mobile device 400 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for trading a digital asset between a seller mobile device and a buyer mobile device, the method comprising:
publishing a public digital asset list from the seller device, the list containing an identifier of the digital asset on the seller mobile device, the public digital asset list accessible over a network;
receiving a trade request at the seller device for the digital asset from the buyer device;
determining payment obligations to an interested party associated with the digital asset;
verifying payment obligations are satisfied;
notifying the interested party of the digital asset trade between the seller device and the buyer device; and
transmitting the digital asset to the buyer device over the network.

2. The method of claim 1, wherein the network is a personal area network.

3. The method of claim 2, wherein the personal area network is comprise of any one of Bluetooth, ad hoc wireless, shared local area network, and infrared.

4. The method of claim 1, further comprising: evaluating a certificate associated with the digital asset to determine if a trading right is associated with the digital asset, and inserting the identifier of the digital asset on the list based on the trading right.

5. The method of claim 4, further comprising obtaining the trading right from an interested party and updating the certificate to allow trading.

6. The method of claim 1, wherein verifying payment comprises determining if an account associated with the seller device has sufficient credit to meet payment obligations to the interested party.

7. The method of claim 6, wherein payment obligations are specified in a certificate associated with the digital asset.

8. The method of claim 7, wherein the payment obligations specify a portion of payment associated with the seller device.

9. The method of claim 8, wherein notifying the interested party comprises providing payment information to the interested party.

10. The method of claim 9, wherein the interested party is any one of a rights owner and a digital asset server.

11. A mobile device for trading a digital asset, the mobile device comprising:
a memory for storing instructions;
a processor coupled to the memory for executing the instructions to configure the processor to publish a public digital asset list, the public digital asset list containing an identifier of the digital asset on the mobile device, the public digital asset list accessible through a network interface of the mobile device; receive a trade request for the digital asset; determine payment obligations associated with the digital asset; verify payment obligations are satisfied; notify an interested party of the digital asset trade between the seller device and the buyer device; and transmitting the digital asset over the network interface of the mobile device.

12. The mobile device of claim 11, wherein the network interface operates based on any one of Bluetooth, ad hoc wireless, shared local area network, and infrared.

13. The mobile device of claim 1, wherein the processor is further configured to evaluate a certificate associated with the digital asset to determine if a trading right is associated with the digital asset, and insert the identifier of the digital asset on the public digital asset list based on the trading right.

14. The mobile device of claim 13, wherein the processor is further configured to obtain the trading right from the interested party through the network interface and update the certificate to allow trading.

15. The mobile device of claim 11, wherein the processor is further configured to verify payment to determine if an account associated with the seller device has sufficient credit to meet payment obligations to the interested party.

16. The mobile device of claim 15, wherein payment obligations are specified in a certificate associated with the digital asset.

17. The mobile device of claim 16, wherein the payment obligations specify a portion of payment associated with the seller device.

18. The mobile device of claim 17, wherein notifying the interested party comprises providing payment information to the interested party.

19. The mobile device of claim 18, wherein the interested party is any one of a rights owner and a digital asset server.
